(19) United States
(12) Patent Application Publication
(10) Pub. No.: US 2009/0312002 A1
(43) Pub. Date: Dec. 17, 2009

(54) METHOD AND SYSTEM FOR SIGNAL FIELD STRENGTH PREDICTION IN COMMUNICATION SYSTEMS

(75) Inventor: Giuseppe Longobardi, Castellammare di Stabia (IT)

Correspondence Address: IBM - EU c/o Myers Andras Sherman LLP, 19900 MacArthur Blvd., Suite 1150, Irvine, CA, 92612, US

(73) Assignee: International Business Machines Corporation, Armonk, NY (US)

(21) Appl. No.: 12/138,356

(22) Filed: Jun. 12, 2008

(51) Int. Cl. H04Q 7/20; H04B 17/00

(52) U.S. Cl. 455/421; 455/67.11; 455/67.7

(57) ABSTRACT

A method and system for communication involving a mobile station and one or more radio base stations providing a signal field in an area, is provided. One implementation includes determining signal field variation at a mobile station in said area due to motion of the mobile station relative to the base stations; and predicting the time remaining to an eventual drop of the signal field by estimating the time remaining to an eventual drop of the signal field based on a rate of variation of the signal field.

### BACKGROUND OF THE INVENTION

### Field of the Invention

The present invention relates generally to communication systems and in particular to signal field strength prediction in communication systems.

### Background Information

With the proliferation of cellular technology and cellular communication systems, there has been increasing need for providing information to cellular users. When users migrate from location to location while using mobile stations for a communication session, such as phone calls on cellular phones or data transfers on a wireless devices, the users are aware of the presence of sufficient signal field coverage, but are unaware of when and how it will change. When making a call on a cell phone or communicating data via a wireless device, specially while in motion (e.g., mobile station moving via a car, bus, train, bike, motorbike), the signal field often changes due to external conditions and the communication session drops suddenly. The same is true for wireless networks, when moving inside or outside buildings. Existing systems only inform a user of the field strength value till the communication session is dropped.

### SUMMARY OF THE INVENTION

The invention provides a method and system for communication involving a mobile station and one or more radio base stations providing a signal field in an area. One embodiment includes determining signal field variation at a mobile station in said area due to motion of the mobile station relative to the base stations; and predicting the time remaining to an eventual drop of the signal field by estimating the time remaining to an eventual drop of the signal field based on a rate of variation of the signal field.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 shows a mobile station and a radio base station of a communication cell, in a communication system.

FIG. 2 shows a mobile station in an area including multiple communication cells.

FIG. 3 shows an active communication cell and adjacent cells.

FIG. 4 shows an example of base station placement for multiple communication cells.

FIGS. 5a-b show other example of base station placement for multiple communication cells.

FIG. 6 shows an example display of information representing signal field strength prediction and predicted time to signal field drop, according to the invention.

FIG. 7 shows a functional block diagram of a signal field strength prediction system that provides information representing signal field strength prediction and predicted time to signal field drop, according to the invention.

FIG. 8 shows a functional block diagram of a process for signal field strength prediction system that provides information representing signal field strength prediction and predicted time to signal field drop, according to the invention.

### DESCRIPTION OF THE PREFERRED EMBODIMENTS

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The description may disclose several preferred embodiments of signal field strength prediction and time remaining to signal field drop, as well as operation and/or component parts thereof. While the following description will be described in terms of such processes and devices for clarity and to place the invention in context, it should be kept in mind that the teachings herein may have broad application to all types of systems, devices and applications.

The invention provides a method and system for field strength prediction for a cellular or wireless network, and evaluating and displaying estimated call duration before a potential wireless connection drop. One implementation involves a field strength prediction module configured for determining the strength of the field of a cellular system, such as an active cell (e.g., global system for mobile communication (GSM) cell) and of adjacent cells (or of a wireless network). This includes determining signal field degradation at a mobile station due to motion relative to an active cell, and estimating the time to an eventual drop of the signal based on the degradation rate and on the strength of the adjacent cells.

Such information, including signal field degradation and estimating time to signal drop, may be provided to a user of the mobile station during a communication session to warn the user that based on the instant conditions, the signal will drop in x minutes. Such information may also be used before initiation of a session (e.g., call, download), knowing in advance that the signal will drop in x minutes.

An embodiment of the invention gathers instantaneous signal field strength of an active cell, and that of adjacent cells, then correlates such information to estimate in advance the time when the signal will eventually drop. This can be implemented in a mobile station (e.g., cell phone, smart phone, PDA) such as a device feature (e.g., directly included in device micro-code) or as a separate plug-in feature (e.g., as downloadable software from a WAP, USB connection, etc).

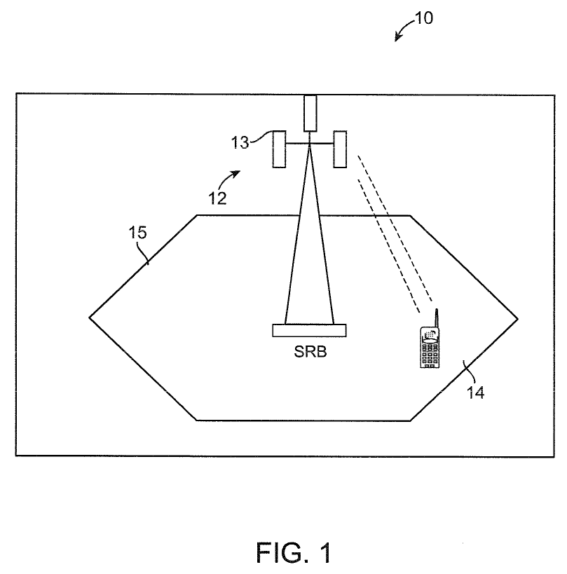

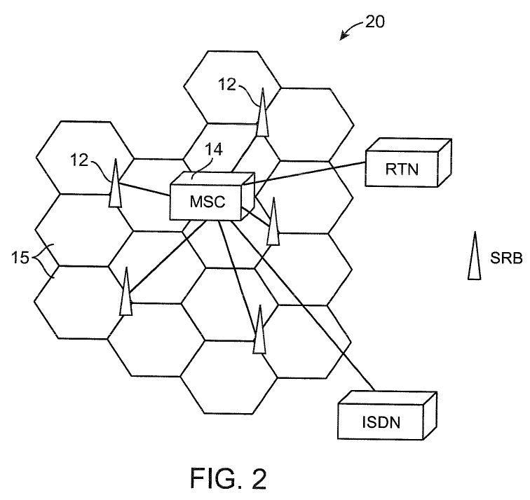

An example implementation for a GSM system is described hereinbelow, however, the invention is applicable to other cellular systems and wireless networks. Referring to FIG. 1, coverage of a GSM system 10 is based on radio base stations (SRB) 12 that handle the cellular signal from a mobile station 14. Each radio base station 12 has a certain number of antennas 13, and the antennas coverage field is denoted as a cell 15. Referring to FIG. 2 an area 20 includes several cells 15. The number of adjacent cells 15 in the area 20 depends on the positioning and orientation of the antennas of radio base stations 12. The number of adjacent cells 15 also depends on the type of antennas used and on the geographical topology of the antenna placements.

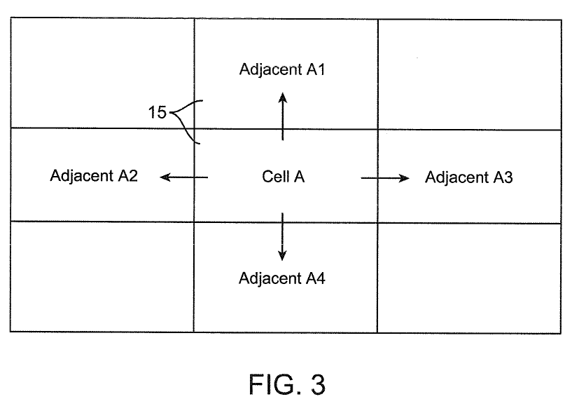

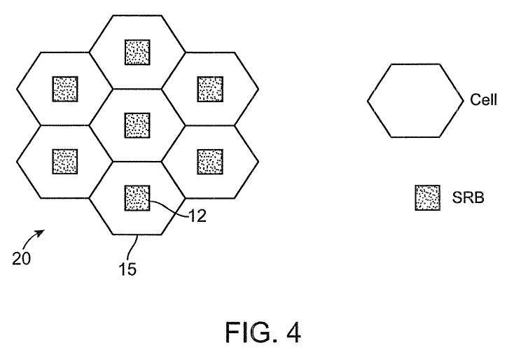

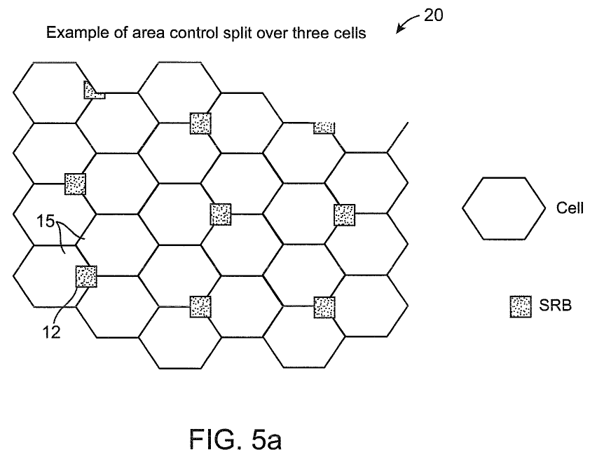

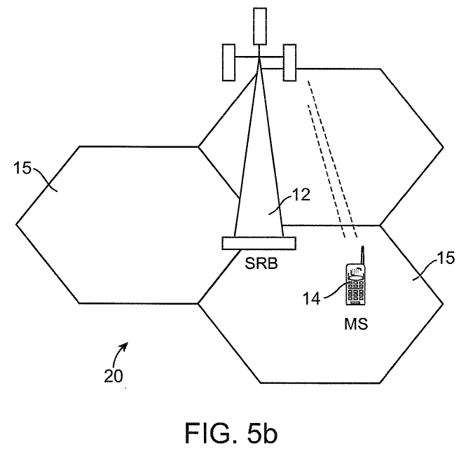

FIG. 3 shows an example of five cells, wherein a central Cell A has adjacent cells Adjacent A1, Adjacent A2, Adjacent A3 and Adjacent A4. Each cell includes a radio base station with antennas oriented for transmission in four directions (e.g., as shown for Cell A). As shown by example in FIG. 4, the base radio station (SRB) 12 for each Cell 15 may be placed in the center of the cell 15. To reduce the number of base radio stations, as shown in FIGS. 5a-b a base station may be positioned across more than one cell (e.g., three cells) in the “clover” disposition.

In every sampling interval, the instantaneous value of the GSM signal field for an active cell is obtained. If the signal field value is decreasing relative to one or more previous samples of the active cell, then values of the GSM fields of the adjacent cells are obtained and compared with the values of the previous samples for each of those fields. Certain samples may be increasing, others may be decreasing, and others may be essentially zero.

Denoting Fₐ(tᵢ) as the value of the signal field of current Cell A at time tᵢ, and Fₐ (tᵢ₋₁) the value at time tᵢ₋₁in case of signal strength decrease, the degradation rate Dₐ of the GSM field for the current cell may be evaluated as: Dₐ(tᵢ)=(Fₐ(tᵢ₋₁)−Fₐ(tᵢ)/(tᵢ−tᵢ₋₁) in case Fₐ(tᵢ)<Fₐ(tᵢ₋₁).

An increment rate, if any, in signal strength of an adjacent cell j may be evaluated as: Iⱼ(tᵢ)=Fⱼ(tᵢ)−Fⱼ(tᵢ₋₁)/(tᵢ−tᵢ₋₁) in case Fⱼ(tᵢ)>Fⱼ(tᵢ₋₁).

Knowing that in the interval tᵢ−tᵢ₋₁ seconds the signal field decreased at a rate Dₐ, assuming that the minimum acceptable signal field value is Fₘᵢₙ based on interpolation, the time to reach the minimum value may be evaluated, wherein:

Deltatomax=Fₐ(tᵢ)−Fₘᵢₙ.

Deltacurr=Fₐ(tᵢ₋₁)−Fₐ(tᵢ).

Interval=tᵢ−tᵢ₋₁.

Steps=Deltatomax/Deltacurr.

Timetominₐᵢ=Steps*interval.

Timetominₐᵢ represents a time period needed at tᵢ to reach the minimum GSM field value in the active cell (Cell A), after which the connection with the base station in Cell A will most likely drop. In the same way, knowing that in the interval tᵢ−tᵢ₋₁ seconds, an adjacent cell j field increased at a rate Iⱼ (assuming that Iⱼ is the maximum value for adjacent cells field strength and the minimum value acceptable is Fₘᵢₙ), if Fⱼ(tᵢ)<Fₘᵢₙ and Iⱼ=MAX(Iᵢ, i=1, n), using interpolation, the time Timetomaxⱼᵢ to increase and reach the minimum acceptable value may be evaluated as:

Deltatomin=Fₘᵢₙ−Fⱼ(tᵢ).

Deltacurr=Fⱼ(tᵢ−1)−Fⱼ(tᵢ).

Interval=tᵢ−tᵢ₋₁.

Steps=Deltatomin/Deltacurr.

Timetomaxⱼᵢ=Steps*interval.

Though linear interpolation is used above to estimate the Timetomaxⱼᵢ , Timetominₐᵢ, non-linear interpolation may also be used, and the value of different signal field strength samples may be utilized to evaluate the coefficient of the non-linear interpolation (a number of samples is needed based on the order of the interpolation). A system of equations may be used to evaluate said values. If the time to reach the minimum value of current Cell A (Timetominₐᵢ) at instant tᵢ is less than the time to reach an acceptable max value in the adjacent cell j (timetomaxⱼᵢ) at the same instant, then timetominₐ of Cell A represents the maximum available time for a communication session between the mobile station and active Cell A in the instant to it has been evaluated (unless there are changes due to movement of the mobile station).

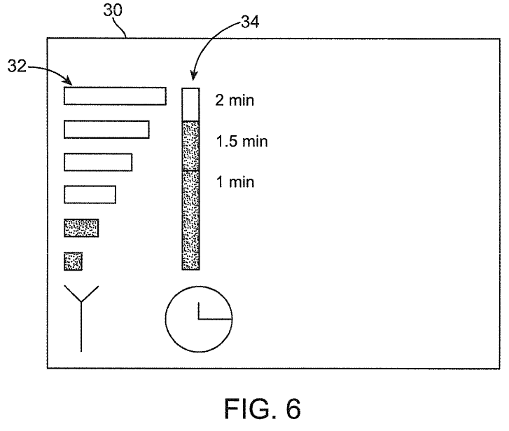

Thereafter, due to the motion of the mobile station, the session may drop due to unavailable field signal from Cell A. In this case, the user may be informed (e.g., via an alarm or prompt on a mobile station display and/or an acoustical voice) about the time period for which the signal will remain available (i.e., time period until a potential signal drop event). This update may be continuous in case of the display, or at certain intervals in case of acoustical prompt. Mobile station settings may allow the user to set the manner of being informed of the time remaining to signal drop (e.g., an acoustic signal/voice, an icon on the display), or a threshold to trigger the informing event (e.g., the time left to signal drop is less than 30 seconds or 1 minute). For example as shown in FIG. 6, in a mobile station display 30, near current (instantaneous) field signal strength bars 32, another graphic such as bar 34 may be displayed to indicate the amount of time remaining till the signal drops according to the invention. The bar 34 may have three segments, wherein, for example, all segments are on when more than 2 minutes remain to signal drop, two segments are on when 1.5 minutes are left, and one segment is on when 1 minute is left till signal drop.

The scale on the display may also change based on the user settings for an alarm trigger on the lowest available value of time (e.g., 5 min. or 10 min.). This may also be applied to other types of transmissions organized in the same manner (e.g., DECT or Local Area wireless Networks). In that case when the signal field is dropping and a field prediction function detects that the field signal may not improve, as soon as the time left to signal drop reaches the time needed to backup data, a session data backup function is initiated to backup, e.g., user data involved in the communication session. An evaluation function as part of the backup function evaluates the time duration needed for backup, or a default time period may be set to be long enough to accommodate the worst case scenario in terms of amount of data that should be backed up. Also in case of a download, if the evaluated backup time is longer than the estimated time period till signal drop, then the download may be blocked with a warning message, leaving to the user the final decision (e.g., user may decide to stop moving with the mobile station to maintain a current signal field strength to complete the communication session).

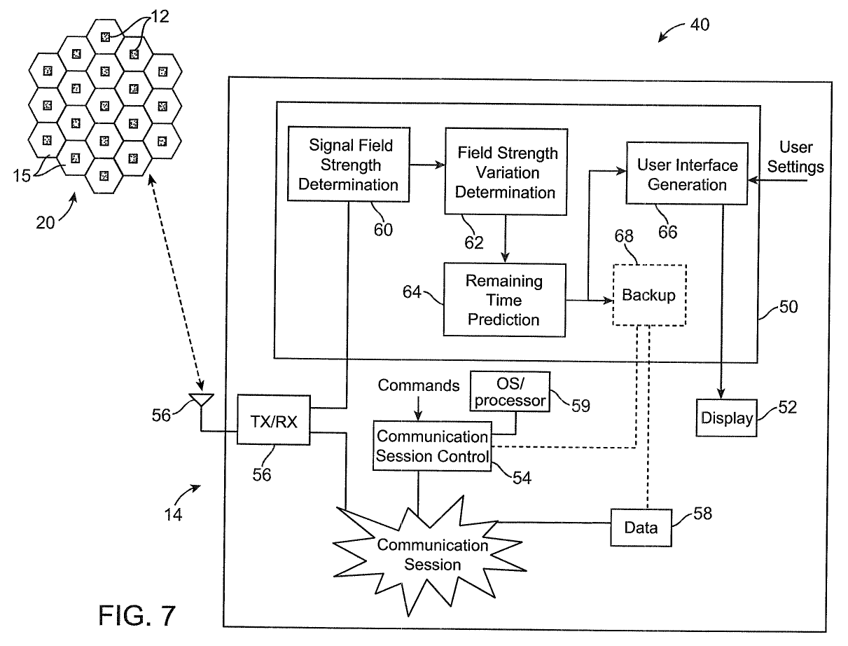

FIG. 7 shows a functional block diagram of a cellular communication system 40 including a mobile station 14 proximate an area 20 including multiple cells 15, serviced by a plurality of base stations 12. The mobile station 14 includes a field strength prediction apparatus 50 for predicting signal fields strength at a mobile station 14 in relation to multiple cells 15, according to an embodiment of the invention.

The mobile station 14 further includes a display module 52, a communication session control module 54, a transceiver (TX/RX) 56, antennas 57 and data 58. The field strength prediction apparatus 50 includes a signal field strength determination module 60, a signal field variation determination module 62, a remaining time prediction module 64, a user interface generation module 66, and optionally a backup module 68 which may backup data 58 of an ongoing communication session based on predictions of the field signal drop. Though the signal fields strength prediction apparatus 50 is shown as a component of the mobile station 14, the apparatus 50 may be e.g., separate from the mobile station 14 or may be downloaded to the mobile station 14 as described herein. The mobile station 14 may be in motion relative to the area 20.

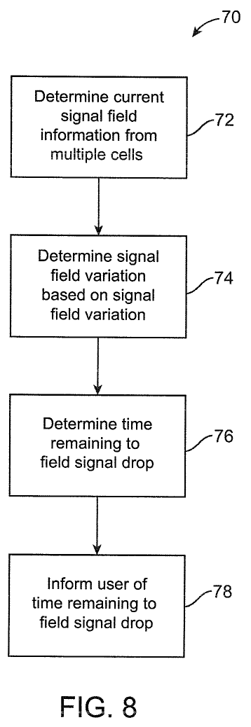

Referring to the example signal field prediction process 70 in FIG. 8, according to an embodiment of the invention, the fields strength prediction apparatus 50 functions as follows in evaluating and displaying estimated communication session duration before a potential field signal drop:

Block 72: The signal field strength determination module 60 uses the transceiver 56 to obtain instant-by-instant current signal field strength information from the base station in active cell in area 20 and that of its adjacent cells in the area 20.

Block 74: The signal field variation determination 62 uses the obtained instant-by-instant signal field strength information to determine signal field increase and/or decrease rates (i.e., evaluates signal field variation trends that may change instant-by-instant due to the motion of the mobile station), using the equations discussed above.

Block 76: The remaining time prediction module 64 uses the determined signal field increase and/or decrease rates (and may use the obtained current signal field information) to locally estimate the time remaining for a possible signal field drop which may interrupt an ongoing communication session.

Block 78: The user interface generation module 66 uses the estimated/evaluated time to a potential signal field drop and displays that information on the display 52 (e.g., FIG. 7). Based on user settings or the default setting, the manner of display or alerts to the user may be selected so that the user is properly informed in advance of a predicted signal drop which may lead to interruption of an ongoing communication session, so that the user can make desired actions/decisions based on such prediction (e.g., via commands to a communication session control module 54 which control communication sessions).

As noted, all or part of the functionality of the apparatus 50 may be included in the mobile station as embedded functionality (e.g., included in the firmware of the mobile station), or all or parts of the apparatus 50 may be downloaded (added) to the mobile station 14 (e.g., as separate applications running on the available mobile station operating system 59). The communication session may be a voice call, data connection, streaming information, etc. The mobile station 14 in the drawings (e.g. FIGS. 1, 2, 5b and 7) implements the function of apparatus 50 according to embodiments of the invention.

The embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer, processing device, or any instruction execution system. For the purposes of this description, a computer-usable or computer readable medium can be any apparatus that can contain, store, communicate, or transport the program for use by or in connection with the instruction execution system, apparatus, or device.

The medium can be electronic, magnetic, optical, or a semiconductor system (or apparatus or device). Examples of a computer-readable medium include, but are not limited to, a semiconductor or solid state memory, magnetic tape, a removable computer diskette, a RAM, a read-only memory (ROM), a rigid magnetic disk, an optical disk, etc. Current examples of optical disks include compact disk-read only memory (CD-ROM), compact disk-read/write (CD-R/W) and DVD.

I/O devices (including but not limited to keyboards, displays, pointing devices, etc.) can be connected to the system either directly or through intervening controllers. Network adapters may also be connected to the system to enable the data processing system to become connected to other data processing systems or remote printers or storage devices through intervening private or public networks. Modems, cable modem and Ethernet cards are just a few of the currently available types of network adapters.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method for communication involving a mobile station and one or more radio base stations providing a signal field in an area, comprising:
determining signal field variation at a mobile station in said area due to motion of the mobile station relative to the base stations; and
predicting the time remaining to an eventual drop of the signal field by estimating the time remaining to an eventual drop of the signal field based on a rate of variation of the signal field.

2. The method of claim 1, further including providing said prediction of the time remaining to an eventual drop of the signal field to a user of the mobile station.

3. The method of claim 2, further including providing event alerts to the user based on said prediction of the time remaining to an eventual drop of the signal field.

4. The system of claim 1, wherein determining signal field variation includes obtaining instant-by-instant current signal field strength information from a base station in active cell base stations and one or more of its adjacent cells.

5. The method of claim 4, wherein determining signal field variation further includes determining signal strength field variation trends based on said instant-by-instant signal field strength information.

6. The method of claim 5, wherein predicting the time remaining to an eventual drop of the signal field includes locally estimating the time remaining for signal field drop based on the signal strength field variation trends.

7. An apparatus for communication involving a mobile station and one or more radio base stations providing a signal field in an area, comprising:
a signal field module configured for determining signal field variation at a mobile station in said area due to motion of the mobile station relative to the base stations; and
a prediction module configured for predicting the time remaining to an eventual drop of the signal field by estimating the time remaining to an eventual drop of the signal field based on a rate of variation of the signal field.

8. The apparatus of claim 7, further including an interface module configured for providing said prediction of the time remaining to an eventual drop of the signal field to a user of the mobile station.

9. The apparatus of claim 8, wherein the interface module is configured for providing event alerts to the user based on said prediction of the time remaining to an eventual drop of the signal field.

10. The apparatus of claim 7, wherein the signal field module includes a signal field strength detection module configured for obtaining instant-by-instant current signal field strength information from a base station in n active cell base stations and one or more of its adjacent cells.

11. The apparatus of claim 10, wherein the signal field module further includes a signal field variation detection module configured for determining signal field strength variation trends based on said instant-by-instant signal field strength information.

12. The apparatus of claim 11, wherein the prediction module includes a remaining time prediction module configured for locally estimating the time remaining for signal field drop based on the signal strength field variation trends.

13. A mobile station for communication with one or more radio base stations providing a signal field in an area, comprising:
a communication module including a transceiver for communication with one or more of the base stations;
a signal field module configured for determining signal field variation at a mobile station in said area due to motion of the mobile station relative to the base stations; and
a prediction module configured for predicting the time remaining to an eventual drop of the signal field by estimating the time remaining to an eventual drop of the signal field based on a rate of variation of the signal field.

14. The mobile station of claim 13, further including an interface module configured for providing said prediction of the time remaining to an eventual drop of the signal field to a user of the mobile station via a user interface device.

15. The mobile station of claim 14, wherein the interface module is configured for providing event alerts to the user based on said prediction of the time remaining to an eventual drop of the signal field.

16. The mobile station of claim 13, wherein the signal field module includes a signal field strength detection module configured for obtaining instant-by-instant current signal field strength information from a base station in active cell base stations and one or more of its adjacent cells.

17. The mobile station of claim 16, wherein the signal field module further includes a signal field variation detection module configured for determining signal field strength variation trends based on said instant-by-instant signal field strength information.

18. The mobile station of claim 17, wherein the prediction module includes a remaining time prediction module configured for locally estimating the time remaining for signal field drop based on the signal strength field variation trends.

19. A computer program product for facilitating communication involving a mobile station and one or more radio base stations providing a signal field in an area, the computer program product comprising a computer usable medium including a computer readable program, wherein the computer readable program when executed on a processor causes the processor to:
determine signal field variation at a mobile station in said area due to motion of the mobile station relative to the base stations; and
predict the time remaining to an eventual drop of the signal field by estimating the time remaining to an eventual drop of the signal field based on a rate of variation of the signal field.

20. The computer program product of claim 19, wherein the computer readable program when executed on the processor further causes the processor to provide said prediction of the time remaining to an eventual drop of the signal field to a user of the mobile station.
